(19) United States
(12) Patent Application Publication
(10) Pub. No.: US 2019/0135017 A1
(43) Pub. Date: May 9, 2019

(54) A SECURITY FEATURE

(71) Applicant: N.V. QUIDING, Schiedam (NL)

(72) Inventor: Juan SANCHEZ-CASTANO, Utrecht (NL)

(73) Assignee: N.V. QUIDING, Schiedam (NL)

(21) Appl. No.: 16/098,809

(22) PCT Filed: May 3, 2017
(86) PCT No.: PCT/EP2017/060469

§ 371 Date: Nov. 2, 2018

(30) Foreign Application Priority Data
May 3, 2016 (NL) 2016724

(51) Int. Cl. B42D 25/324; A44C 21/00; B42D 25/29; G02B 5/124

(52) U.S. Cl. CPC B42D 25/324; G02B 5/124; B42D 25/29; A44C 21/00

(57) ABSTRACT

The invention relates to a security feature (100, 200, 300) comprising cells (10A), wherein at least a predetermined number of the cells (10A) have an equiangular quadrilateral base and each cell (10A, 10B, 10C, 110, 1) of the predetermined number of the cells (10A) has facets (1, 301) for forming a plurality of images, wherein each of these images is observable from a different direction. Each facet (1, 2) for forming an image has at least three vertices with a different height (H1) in a three dimensional space.

The invention relates to a security feature comprising cells, wherein at least a predetermined number of the cells have an equiangular quadrilateral base and each cell of the predetermined number of the cells has facets for forming a plurality of images, wherein each of these images is observable from a different direction.

The invention further relates to an object comprising a surface wherein at least a part of the surface has a security feature.

EP 2 594 149 discloses and shows in FIG. 1 thereof an object (1) comprising a surface wherein at least a part (R) of the surface of the object has a security feature comprising a number of cells (1,1). The cells may define triangular-, square- or hexagonal-based pyramids. The four faces of the square based pyramid cells are facets. These facets are flat faces, each of them associated with an image. A part of a surface of the object made up of this type of cells is capable of showing four independent images. For producing images this type of cells increases the inclination of facets, i.e. the angle formed between a facet and the (virtual) bottom surface of the cell. The way this is done in EP 2 594 149 has the drawback that a sector parallel to the bottom (see FIG. 4, B1) is created in the cell. This system increases the number of side facets when more than one side facet changes its inclination. In addition, this sector is undesired and it may create noise in the transitions from one image to the other as this bottom plane appears between the images.

It is a goal to provide an object with a security feature capable of showing independent images in a clear fashion, wherein each cell of the security feature has an equiangular quadrilateral base.

This goal is achieved with the security feature as defined in claim 1.

The security feature according to claim 1 is developed with triangular facets having three vertices in three different heights in a three dimensional space (Z axis) and/or with polygonal facets having at least three vertices in three different heights in a three dimensional space (Z axis). In the known security feature of EP 2 594 149 the relief for the facets of the cells originates from the shape of the base, such that the sides of the base determine the number of facets. This also means that the facets will always have two vertices of the triangular or polygon facet, resting on the base, therefore, at least two of the vertices of each facet will have the same height. Changing the orientation of one or more associated facets in the known cell for forming an image is done by introducing the undesired sectors.

The vertices of each facet with three different heights allows the planes of the facets to change their normal in space as desired without creating undesired sectors in the cell. This also still allows the facet (reflection plane) to reflect the light individually and independently from other adjacent reflection planes in the same cell. The facets having three vertices in three different heights in a three dimensional space provide an engineer or a designer of the security feature more freedom in design, while the number of non-contributing sectors in the security feature can be reduced to zero. This not only improves the quality of the image to be shown, but also provides the opportunity to increase the number of images to be shown with each cell without blur or mixing between the images.

It is possible to use a pentagon, an octagon or a circle as a base shape for the cell. However, the cells with these bases provide empty spaces in between the cells, such that information can be missed and the resolution of an image may be decreased. Further, the empty spaces may introduce noise in the images to be shown. By using equiangular quadrilateral bases of the cells of the security feature according to the present invention, empty spaces between the cells and the associated drawbacks of these empty spaces can be avoided.

Another problem of a polygon base with more than four sides is the angle between adjacent facets. This angle can be very obtuse, such that the light can be reflected by two facets or more facets at a time, which may result in several images appearing simultaneously, giving a blur image.

The facet having at least three vertices in three different heights in a three dimensional space way is capable of solving the problem of the obtuse angle between adjacent facets such that it is possible with the security feature of the present invention to provide more than six images, one at a time, without blur or mixing with other images. A facet having at least three vertices in three different heights in a three dimensional space also ensures that none of the facets of each cell coincides with a virtual horizontal base plane defined by the corners of the base of each cell, i.e. the virtual horizontal base plane is a surface what would correspond if there was no relief provided by the facets. This virtual horizontal base plane defined in the XY plane has no height, i.e. Z=0. Not using the horizontal base plane also promotes that no interferences are shown in the process of an animation to be created with the images of the moving security feature. In fact, the surface of the cell of one of the predetermined cells only consists of facets such that the virtual horizontal base plane of the cell is not a part of the surface of the cell visible from above.

In one aspect of the security feature, one of the at least three vertices of each facet rests on the perimeter of the virtual horizontal base plane defined by the four corners of the cell.

Each cell of the security feature may contain at least two facets (reflecting surfaces) in relief where light will be reflected to a viewer when seen from the proper angle to show at least two images to the viewer. The equiangular quadrilateral base of each cell can be divided with a regular distribution or irregular distribution to provide the facets of a cell. A regular distribution means that the base is divided in portions by a line or lines crossing the centre of the base. In a regular distribution with more than one line the facets of the cell have a common vertex in the centre of the cell. Hence, it is possible to divide each cell with a regular distribution in eight, twelve or in sixteen facets to show eight, twelve or sixteen images. With the cell it is also possible to show more than sixteen images. Further, the equiangular quadrilateral base of each cell can be divided with an irregular distribution by moving the common point from the centre of the base to another position in the X, Y plane such that the common vertex of the facets is not located in the centre of the cell.

Further, it is also possible to change the height of the common vertex. Hence, the position (X,Y,Z) of the common vertex can be used by a designer to change the normal to the surface of each of the facets to produce the images.

In another structure, the facets of each cell can also be configured following a Delaunay triangulation pattern structure, and the facets of such a cell will not share a single common vertex, but the facets have more than one vertices that are shared by/common for a number of facets in the cell, i.e. at least three vertices in a three dimensional space within the borders of the cell (not on the border/perimeter of the cell). Further, the at least three shared vertices of a cell with a Delaunay triangulation pattern structure can have at least two different heights.

Each facet of the cell can be subdivided in three or four smaller facet planes which have a common vertex. The position (X,Y,Z) of the common vertex in the centre of the facet can also be varied. For example, the height (Z axis) of the common vertex of the smaller facet planes can be varied, creating a different shading and contrast of the image. Hence, in the security feature according to the present invention it is possible for a designer to change the inclination of the facets and/or the smaller facet planes by combining various variations in the X, Y, Z coordinates of the vertices of the facets in each cell. It is also possible to vary the distance between at least two vertices of a facet situated on the perimeter of the cell to change the normal of the facet.

By subdividing the facets of the cell in three or maximally four smaller facet planes (depending on the structure) clear individual images can be formed. None of these smaller facets planes are part of the virtual horizontal base plane of the cell. By using the smaller facet planes it is possible to obtain a security feature with an open structure seen from above. Objects to be made with a security feature having these smaller facet planes can be produced more efficient because the open structure provides a better flow of material to produce the object with the security feature. Also, the pressure necessary to obtain the relief on the object can be reduced such that the life time of a die or a plate used to produce the objects can be extended drastically.

These smaller facet planes can be set up by tracing the incenter of the facet, using the incenter to project three smaller facet planes to the edges of the original facet. In case the facet is formed by four sides, a circle can be provided which touches the four sides of the polygon, and from the center of this circle four smaller facet planes are projected to the edges of the shape of the original facet. The images produced by the smaller facet planes can be shown to a viewer in an animated fashion.

The security feature can be used at least on a part of a surface of an object, for example a coin, a bank card or a banknote. The security feature as defined herein allows mass production for example by means of printing, stamping or minting techniques and most importantly complicates the reproduction of the object by unauthorized manufacturers.

The invention also relates to a method of producing a die or a plate for stamping, embossing, hobbing, coining or printing the above described security feature on or in an object by using an external system provided with a laser, a processor and a computer program which in use instructs the processor to operate the laser to manufacture the security feature in the die or the plate. Further, the invention relates to using the die or the plate produced in this method.

The invention will now be explained in more detail on the basis of exemplary embodiments in the appended drawings, in which:

FIG. 1 shows an equiangular quadrilateral base of a cell of a security feature subdivided in eight portions;

FIG. 2 shows an equiangular quadrilateral base of a cell of a security feature subdivided in a different way in eight portions compared to the base shown in FIG. 1;

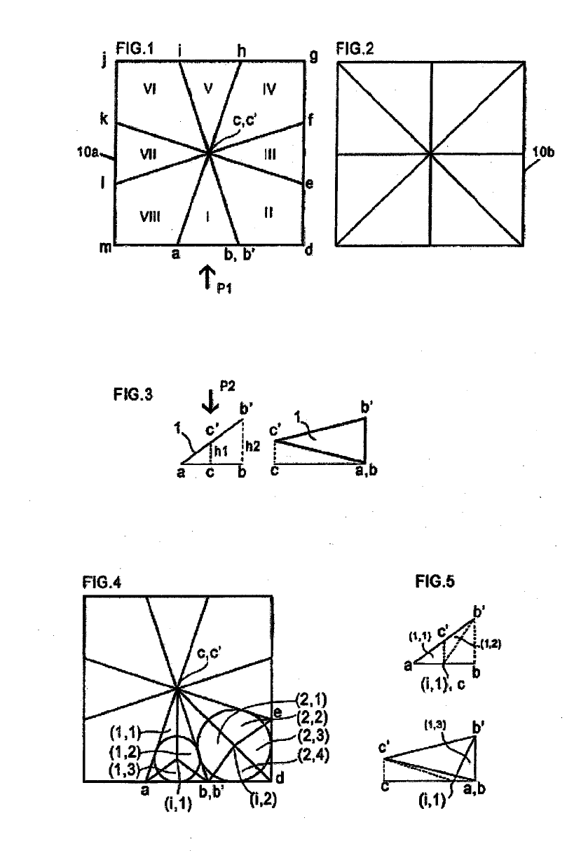

FIG. 3 shows a front view of a portion of the cell shown in FIG. 1 and a side view from the left of a portion of the cell shown in FIG. 1;

FIG. 4 shows the cell of FIG. 1, wherein two facets is subdivided into more smaller facet planes;

FIG. 5 shows a front view of a portion of the cell shown in FIG. 4 and a side view from the left of a portion of the cell shown in FIG. 4;

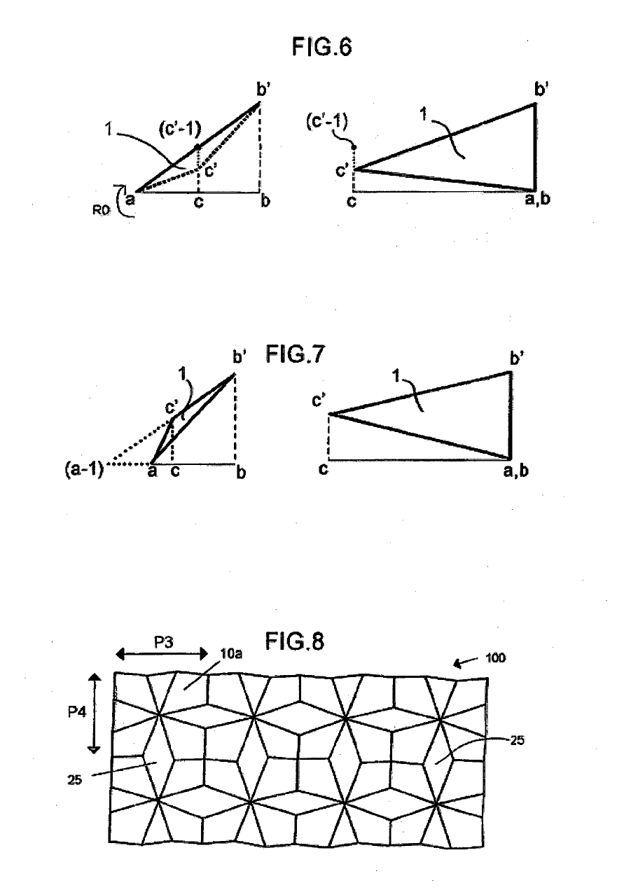

FIGS. 6 and 7 show two design parameters to change the normal of the facets;

FIG. 8 shows a top view of a part of a first embodiment of a security feature in which the cells have been aligned to each other such that two adjacent cells provide a common facet plane (diamond like);

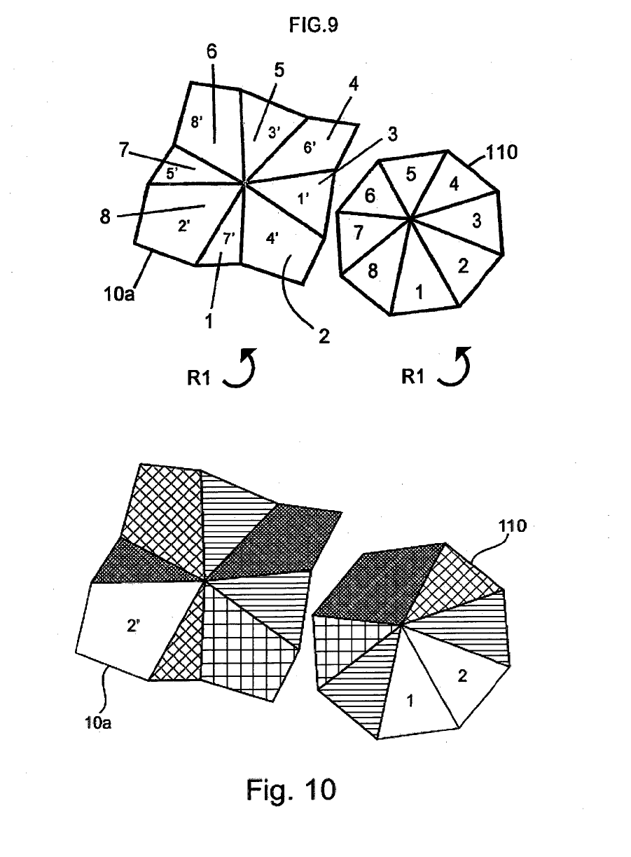

FIGS. 9 and 10 show a cell of a security feature of the invention compared with a cell having an octagon base;

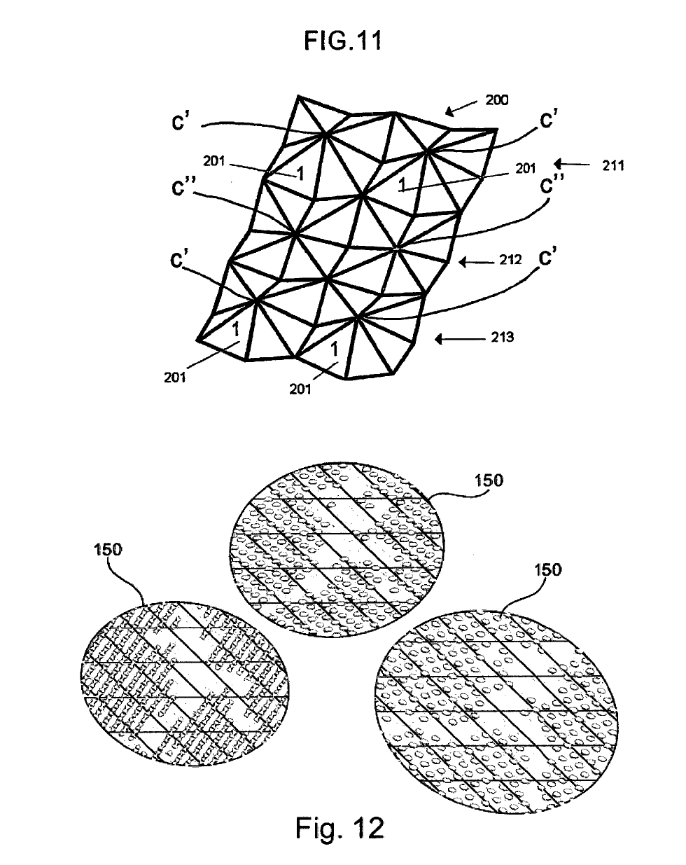

FIG. 11 shows a perspective of a second embodiment of the security feature of the invention;

FIG. 12 shows a coin showing an animation provided with the security feature;

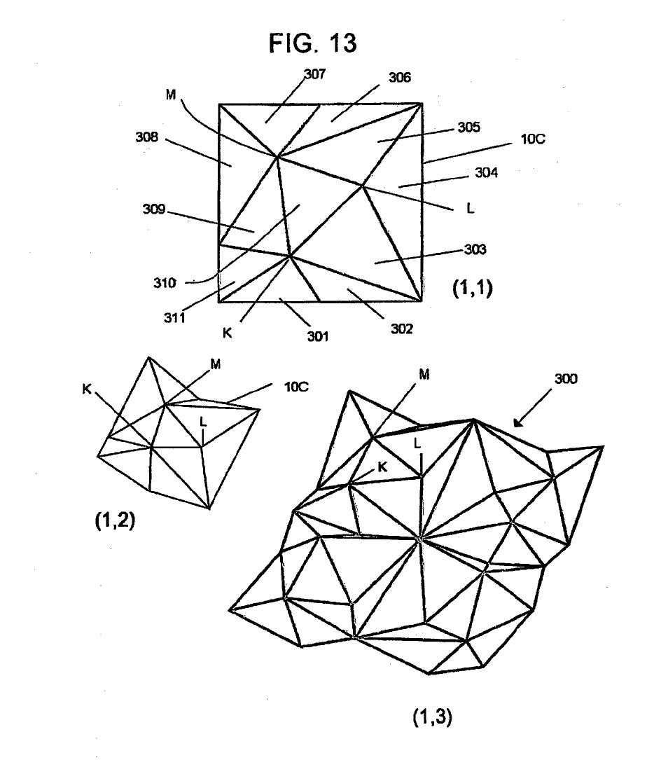

FIG. 13 shows a top view of an equiangular quadrilateral base of a cell of a third embodiment of the security feature, a perspective view of the same cell and four of these cells forming a part of the security feature.

Like parts are indicated by the same numerals in the figures.

FIG. 1 shows a top view of a cell 10a of a security feature 100 subdivided in eight unequal portions I-VIII. These portions are unequally subdivided because the surface areas of two adjacent portions I, II differ from each other. Nevertheless, the base of the cell 10a is divided with a regular distribution to provide the eight portions, in that the base is divided by lines crossing the centre c of the base. The eight facets to be formed with these eight portions I-VIII of the cell 10a have a common centre c′.

The cell 10a shows two types of portions, i.e. the triangular and polygon portions. The triangular portions I, III, V, VII are identical to each other and have the same surface area. The same applies to the polygon portions II, IV, VI, VIII. The polygon portions II, IV, VI, VIII have a larger surface area than the triangular portions I, III, V, VII.

FIG. 2 shows a top view of a cell 10b with a regular distribution wherein the portions of this cell 10b are identical, i.e. all these portions are defined by triangles with the same surface area and with the same angles.

The base of the cell 10a, 10b shown in FIGS. 1 and 2 is a equiangular quadrilateral base defined in the X, Y plane, in particular a square base. The portions correspond to facets to be formed and these facets will be discussed in more detail below.

FIG. 3 shows in the left a front view of a part of a cell of FIG. 1 which is also identified with the arrows P1 and P2 in FIGS. 1 and 3. In the right of FIG. 3 a side view is shown of a part of a cell of FIG. 1. FIG. 3 shows the height (Z axis, i.e. the direction shown by b-b′ or c-c′) of a cell 10a. FIG. 3 also shows the orientation of a facet 1 of a cell compared to a virtual horizontal base surface (X, Y plane) which would correspond to a surface if there were no facets. In the left of FIG. 3 the virtual horizontal base plane surface having a height Z=0 is defined by points a−b and in the right of FIG. 3 by points c−a, b.

The cells 10a, 10b comprise eight facets 1-8 as shown for example for cell 10a in FIG. 9. Each facet 1-8 of the cell 10a, 10b for forming an image has at least three vertices with a different height (Z axis) in a three dimensional space (X, Y, Z).

As shown in FIG. 3 facet 1 has three vertices a, b′ and c′. If vertex a lies in the virtual horizontal base plane surface having no height, i.e. Z=0, then vertex c′ may have a first height h1 and vertex b′ may have a second height h2, wherein in the example shown h2 is greater that h1. For example, h2 can be two times h1, such that if h1 would have a height h1 of Z=1 than h2 would be Z=2. Of course, different configured vertices (not shown in FIG. 3) are also possible. For example, vertex a can also have a greater height than vertex b′, and/or vertex c′ can have a different height for example a height Z=0.

In the embodiment shown in FIG. 3 one of the vertices of the facet 1 rests on the perimeter of the virtual horizontal base plane surface which would be in the example shown vertex a. Further in the examples shown in the FIGS. 1-12, all the facets of a cell 10a, 10b have a common vertex c′ in the centre of the cell 10a, 10b. In the examples shown in FIGS. 1-10, at least two vertices of the facet situated on the perimeter of the cell define the vertex with the minimum height, e.g. vertex a for facet 1, and the vertex with the maximum height, e.g. vertex b′ for facet 1. FIG. 11 shows an example where the common vertex c′ is the vertex with the maximum height.

The inclination of the facets 1-8 can be changed by a designer by varying the position (X, Y, Z) of the common vertex c′ in a three dimensional space. By changing the inclination, the orientation of the facet changes and therefore the normal to the surface of each facet.

In order to avoid horizontal planes in a cell 10a, 10b, each facet 1-8 of the cells 10a, 10b of the security feature has an inclination with respect to a virtual horizontal base plane surface (X, Y plane).

In FIGS. 4 and 5 a subdivided cell 10a is shown, in particular the subdivision of the facets 1, 2 of the cell 10a is shown in three (1,1), (1,2), (1,3) and four smaller facet planes (2,1), (2,2), (2,3), (2,4) to create images with a predetermined number of cells 10a of the security feature 100. As shown in FIG. 4 these smaller facet planes can be set up by tracing the incenter (i, 1) of the triangle by means of a circle touching all three sides of the triangle of the facet 1. This incenter (i, 1) is situated on the virtual horizontal base plane and the three smaller facet planes are projected therefrom to the vertices a, b′, c′ of the shape of the original raised facet 1. In case the facet 2 is formed by four sides, a circle can be provided which touches the four sides of the polygon shaped facet 2 to provide the center (i, 2). This center (i, 2) is situated on the virtual horizontal base plane and therefrom four smaller facet planes are projected to the vertices of the shape of the original raised facet 2. The smaller facet planes of each facet have a common vertex (i, 1), (i, 2).

These smaller facet planes of the facets make it possible to obtain clear individual images. None of these smaller facets planes are part of the virtual horizontal base plane of the cell 10a. With this structure of the cell 10a the influence of noise in the images can be reduced drastically.

FIGS. 6 and 7 show a possible variation in the orientation of the facet 1 which can be changed easily by a designer to the desired inclination by changing the height of the common vertex (c′−1) to c′ of the facet 1 such that the normal to the surface of facet 1 of the cell can be varied. Lowering the height of the common vertex (c′−1) to c′ of the facet 1 as shown in FIG. 6 results in a rotation of the facet 1 in the rotation direction R0 around the virtual rotation axis a−b′. It is also possible to raise the height of the common vertex (not shown).

In addition, it is also possible as shown in FIG. 7 to change the distance between at least two vertices a, b′ of the facet 1 situated on the perimeter of the cell from the distance (a−1)−b′ to the smaller distance a−b′ to vary the normal of the facet 1.

FIG. 8 shows a perspective view of a part of a security feature 100, wherein the arrows P3 and P4 are used to indicate the cell 10a shown in FIG. 1. Such a security feature can be provided on at least a part of a surface of an object. The object can be a coin, a bank card or a banknote. The cells in FIG. 8 have been aligned to each other such that two adjacent cells provide a common (diamond like) facet plane 25 consisting of a triangular facet of each cell. The common (diamond like) facet plane 25 has a large surface area which can be used by a designer to obtain images.

FIGS. 9 and 10 show perspective views of the cell 10a of a security feature of the invention compared with a cell 110 having an octagon base. The cell 110 has an obtuse angle between the adjacent facets 1, 2, such that the light is reflected by these two facets at the same time as shown in FIG. 10, which results in several images appearing to an observer simultaneously, giving a blur image. The cell 10a uses facets 1-8 with three different heights which solves the problem of the obtuse angle between adjacent facets such that eight independent images can be displayed by using cell 10a, one at a time, without blur or mixing with others.

The shining order of cell 10a also differs from the shining order of cell 110 if these cells 10a, 110 are rotated in a direction indicated by arrow R1 around a vertical axis extending through the common vertex of each cell. In the cell 110 the facets shine clockwise, i.e. in a sequence how the facets 1-8 of cell 110 have been numbered. In the cell 10a the order of shining can be determined by the designer by varying the position (X,Y,Z) of the vertices of the facets 1-8 in a three dimensional space. The predetermined shining order has been indicated by 1′, 2′, 3′, 4′, 5′, 6′, 7′ and 8′ in the cell 10a shown in FIG. 9. Due to the predetermined shining sequence order, the facets in the cell 10a do not shine side by side which enhances the quality of an animation with the images to be displayed.

A security feature 100 with cells stamped on a coin 150 as shown in FIG. 12 is able to show an animation (a running man) as the coin 150 is rotated around its vertical axis, wherein this vertical axis is an imaginary line perpendicular to the centre of the circle of the coin 150. Regarding the animation, Beta movement and Phi effect can be obtained. Instead of an animation it is also possible to display independent images (not shown) with the security feature 100.

FIG. 11 shows a perspective of a second embodiment of the security feature 200 of the invention. The part of the security feature 200 shown comprises a first row 211 with identical cells, a second row 212 with identical cells which are different from the cells in the first row and a third row 213 with identical cells which are identical to the cells of the first row 211. Each cell has a configuration corresponding to cell 10b shown in FIG. 2, i.e. a regular distribution with triangular facets 201. Each cell of the first row 211 and third row 213 has a common vertex c′. This common vertex c′ has the maximum vertex height in the security feature 200. Each cell of the second row 212 has a common vertex c″ which has a lower height than the maximum vertex height. Such a configuration of rows 211, 212, 213 can be used to increase the number of images to be shown with the security feature 200, because it is possible by using two different cells in at least two rows 211, 212, 213 to show sixteen independent images with the security feature 200 using cells having eight facets.

FIG. 13 shows a top view of an equiangular quadrilateral base of a cell 10c of a third embodiment of the security feature 300, a perspective view of the same cell 10c and four of these cells forming a part of the security feature 300.

In the cell 10c, the facets 301, 302, 303, 304, 305, 306, 307, 308, 309, 310, 311 of each cell 10b are configured with an irregular distribution, in particular the facets are configured following a Delaunay triangulation pattern structure. Using a Delaunay triangulation pattern structure makes it possible to further increase the number of images to be shown with the security feature 300. The facets of such a cell do not share a single common vertex (as shown in the examples shown in FIGS. 1-11), but the facets have more than one vertices that are common for a number of facets in the cell, i.e. at least three shared vertices K, L, M in a three dimensional space within the borders of the cell (not on the border/perimeter of the cell). Each of the shared vertices is a shared vertex of at least four facets. Further, the three shared vertices K, L, M of a cell of a Delaunay triangulation pattern structure may have three different heights.

It is also possible to divide the equiangular quadrilateral base of each cell (not shown) with an irregular distribution by moving a single common point from the centre of the base to another position in the X, Y plane such that the common vertex of the facets is not located in the centre of the cell.

Instead of dividing the base in eight facets, it is also possible to divide the base in more or less than eight facets. It is also possible to combine for example cells with three facets with cells having two facets to obtain five images or to rotate the same cell to make the double of possible shining facets.

It is possible to produce a die or a plate for stamping, embossing, hobbing, coining or printing a security feature as described herein by using a laser. For example, rapid prototyping or printing can be used to obtain the objects having the above described security feature directly or to obtain the die or the plate to produce the object with the security feature. Rapid prototyping can be used to provide the security feature in micro- and nanostructures. Rapid prototyping can comprise additive manufacturing processes, such as stereolithography and/or subtractive manufacturing, such as CNC milling and turning.

1. A security feature comprising cells, wherein at least a predetermined number of the cells have an equiangular quadrilateral base and each cell of the predetermined number of the cells has facets for forming a plurality of images, wherein each of these images is observable from a different direction, characterized in that each facet for forming an image has at least three vertices with a different height in a three dimensional space.

2. The security feature according to claim 1, wherein at least one of the vertices of each facet rests on the perimeter of a virtual horizontal base plane surface which would correspond to a surface if there were no facets.

3. The security feature according to claim 1, wherein the equiangular quadrilateral base is divided in more than six portions for forming facets.

4. The security feature according to claim 1, wherein the facets of each cell have at least one common vertex.

5. The security feature according to claim 4, wherein the position (X, Y, Z) of the common vertex in a three dimensional space can be varied to change the normal to the surface of each facet.

6. The security feature according to claim 1, wherein the equiangular quadrilateral base is a square base.

7. The security feature according to claim 1, wherein a vertex of the facet situated on the perimeter of the cell defines the vertex with the minimum height or the vertex with the maximum height.

8. The security feature according to claim 1, wherein the distance between at least two vertices of a facet situated on the perimeter of the cell can be varied to change the normal of the facet.

9. The security feature according to claim 1, wherein each facet can be subdivided in three or four smaller facet planes, which have a common vertex.

10. The security feature according to claim 9, wherein the position (X, Y, Z) of the common vertex of the smaller facet planes can be varied in a three dimensional space to change the normal to the surface of each of the smaller facet planes of the facet.

11. The security feature according to claim 1, wherein movement of the security feature provides an animation to an observer, wherein the facets producing the images for the animation to an observer follow a predetermined order of sequence.

12. The security feature according to claim 1, wherein the surface of each cell of the predetermined number of cells visible from above consists of facets.

13. An object comprising a surface wherein at least a part of the surface has a security feature according to claim 1.

14. The object of claim 13, wherein the object is a coin, a bank card or a banknote.

15. Method of producing a die or a plate for stamping, embossing, hobbing, coining or printing a security feature according to claim 1 on or in an object by using an external system provided with a laser, a processor and a computer program which in use instructs the processor to operate the laser to manufacture the security feature in the die or the plate.

16. (canceled)
